(19) United States
(12) Patent Application Publication
(10) Pub. No.: US 2023/0394603 A1
(43) Pub. Date: Dec. 7, 2023

(54) Distributed System For Energy Storage And Energy Demand Shifting

(71) Applicant: blip, LLC, Evanston, IL (US)

(72) Inventors: Chance Cobb, Evanston, IL (US); Sophia Wennstedt, Evanston, IL (US); Dennis Kontorovich, Evanston, IL (US); Thibaut Feremans, Evanston, IL (US)

(21) Appl. No.: 18/248,051

(22) PCT Filed: Oct. 8, 2021
(86) PCT No.: PCT/US2021/054241

§ 371 Date: Apr. 5, 2023

Related U.S. Application Data
(60) Provisional application No. 63/231,670, filed on Aug. 10, 2021.
(60) Provisional application No. 63/089,166, filed on Oct. 8, 2020.

(51) Int. Cl. G06Q 50/06; H02J 7/00; G06Q 30/0283

(52) U.S. Cl. CPC G06Q 50/06; H02J 7/0063; H02J 7/0048; G06Q 30/0283

(57) ABSTRACT

Systems and methods for shifting energy demand are described herein. An energy management computing system can monitor energy prices and send commands to a residential energy storage device to discharge at periods when energy prices are relatively high. Alternatively, the energy storage device can receive energy prices and determine when to discharge in order to reduce costs when energy prices are relatively high. In yet another alternative, an energy distributor can take advantage of a plurality of energy storage devices to shift energy demand during periods of peak demand.

### RELATED APPLICATIONS

The present application is a 371 national phase filing of PCT Application No. PCT/US2021/054241 filed Oct. 8, 2021, which claims the benefit of U.S. Provisional Patent Application No. 63/089,166 filed Oct. 8, 2020 and U.S. Provisional Patent Application No. 63/231,670 filed Aug. 10, 2021. The entire contents of the foregoing applications are hereby incorporated herein by reference.

### TECHNICAL FIELD

Embodiments of the technology relate generally to energy storage and specifically to systems and methods for the management of residential energy storage.

### BACKGROUND

While there are some energy storage control schemes already in existence, they do not facilitate widespread use among consumers and they ignore the viable market of demand shifting that will be useful in making our electric grid more resistant to failures while also enabling a transition away from inefficient and/or environmentally harmful power plants used during times of peak energy demand, known as “peaker plants.” The former concern is important in places such as California that face yearly blackouts during summer months to prevent wildfires or in response to wildfires combined with increased demands due to worsening heatwaves tied to climate change. The latter concern is important for combating climate change by addressing the need to flatten energy demand curves by reducing demand at peak times during the day. Accordingly, as described further below, improved systems and methods for widespread demand shifting, particularly during peak energy demand time periods, would be desirable.

### SUMMARY

In one example embodiment, the present disclosure is directed to a computer-implemented method for managing an energy storage device from a remote energy management computing system. The method can comprise obtaining, at the energy management computing system, an energy price for energy supplied by a utility associated with a user; and comparing the energy price with a price setting determined by the user. Responsive to the energy price satisfying the price setting, the energy management computing system can transmit to a controller of an energy storage device associated with the user, a discharge command. The discharge command causes the energy storage device to complete a discharge cycle during which the energy storage device delivers power from a battery system to an electrical appliance coupled to the energy storage device.

In another example embodiment, the present disclosure is directed to a computer-implemented method for an embedded controller to locally manage an energy storage device. The computer-implemented method can comprise receiving, at the controller of the energy storage device from an energy management computing system, an energy price for energy supplied by a utility associated with a user. The controller can compare the energy price with a price setting determined by the user. Responsive to the energy price satisfying the price setting, the controller can switch the energy storage device from a charge mode to a discharge mode. The discharge mode causes the energy storage device to complete a discharge cycle during which the energy storage device delivers power from a battery system to an electrical appliance coupled to the energy storage device.

In another example embodiment, the present disclosure is directed to a computer-implemented system for an energy distributor system to leverage a plurality of energy storage devices for energy demand shifting. The computer-implemented method can comprise receiving, at an energy management computing system from an energy distributor computing system, a request for energy storage device availability at an identified peak demand time. The energy management computing system can identify for the energy distributor computing system a plurality of energy storage devices available at the identified peak demand time by comparing the identified peak time to profile data associated with the plurality of energy storage devices. The energy management computing system can receive from the energy distributor computing system, selected energy storage devices of the plurality of energy storage devices for demand shifting. The energy management computing system can transmit to the selected energy storage devices, a discharge command, wherein the discharge command causes the selected energy storage devices to complete a discharge cycle during which the selected energy storage devices deliver power from a respective battery system to a respective electrical appliance.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of the disclosed systems and methods and therefore are not to be considered limiting of the scope of this disclosure. The principles illustrated in the example embodiments of the drawings can be applied to alternate systems and methods. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates a system of energy storage devices that can be used for shifting energy demand in accordance with an example embodiment of the disclosure.

FIG. 2 is an illustration of an energy storage device in accordance with an example embodiment of the disclosure.

FIG. 3 is a flow chart illustrating a method for configuring an energy storage device in accordance with an example embodiment of the disclosure.

FIG. 4 is a flow chart illustrating a method for configuring an uninterruptible power supply mode and a smart mode of an energy storage device in accordance with an example embodiment of the disclosure.

FIG. 5 is a flow chart illustrating a method for operating an energy storage device in accordance with an example embodiment of the disclosure.

FIG. 6 is a flow chart illustrating a method for operating an energy storage device in accordance with another example embodiment of the disclosure.

FIG. 7 is a flow chart illustrating a method for operating an energy storage device in accordance with yet another example embodiment of the disclosure.

FIG. 8 illustrates a computing system which can be implemented as one or more of the computing systems described herein in accordance with the example embodiments of the disclosure.

### DETAILED DESCRIPTION OF EXAMPLE EMBODIMENTS

The example embodiments discussed herein are directed to systems and methods for shifting energy demand. In one example, the demand shifting techniques described herein can be used by consumers to save on energy costs during peak demand time periods. As another example, the demand shifting techniques described herein can be used by energy distributors to reduce demand during peak demand time periods. The demand shifting techniques described herein can also use predictive analytics to predict when demand shifting would be beneficial and to predict the availability of residential energy storage devices for use in demand shifting.

A consumer-side solution offers unique opportunities when considering incentives. While energy providers have incentives in terms of being able to adequately supply customers with electricity at all times, the cost of developing energy storage infrastructure on the utility side is prohibitive, especially when energy providers can charge premiums to consumers on time-of-use plans during peak hours. However, by providing consumer-side energy storage, consumers can save money by using a time-of-use plan wherein they use less electricity during peak operating hours. Further, as already stated, these consumer-side storage capabilities benefit utilities as they can shift energy demand and move away from using more expensive and harmful peaker plants without having to invest in the energy storage infrastructure themselves.

The systems and methods described herein enable an optimal solution wherein consumers benefit with price savings and protection against power outages, while utilities also benefit in investment-free cost savings by avoiding the need to run fewer peaker plants, avoiding investment in their own utility-side energy storage infrastructure, and being able to shift demand during peak demand times or during emergencies.

In one example, the disclosed embodiments provide a system that operates cross-platform on web browsers, mobile phones, and an embedded controller in an energy storage device (sometimes referred to as an ESD). The energy storage device is associated with a consumer and can be located in a residence or business. In some instances, the consumer can have multiple energy storage devices. The example system enables minimization of energy usage from the grid during peak demand times when electricity is more costly. Instead, the energy storage device charges from the electric grid during off-peak times when electricity is less costly and the energy storage device discharges to provide power to an attached appliance during peak demand times. The energy storage device can use standard residential electrical connections, such as but not limited to the 120V 60 Hz AC standard used in North America. The energy storage device can include a plug that connects to a standard residential receptacle for charging the energy storage device during off-peak times. In other words, the energy storage device is simple to install and use because it is not hard-wired to a breaker panel. The energy storage device also can include one or more receptacles for connecting one or more electrical appliances to the energy storage device and for supplying stored power from the energy storage device to the one or more electrical appliances during peak demand times.

The example systems and methods described herein also enable third party energy distributors to leverage the benefits of energy storage devices deployed in multiple residences. Third party energy distributors can call on available energy storage devices to shift demand by power appliances during periods of peak demand to flatten demand curves or prevent power outages. A further advantage of the embodiments described herein is that the the energy storage devices provide a decentralized source of power in that they can be distributed over many customers. A decentralized solution helps to avoid congestion, to avoid the need to transmit the power over distances, and avoids other weaknesses in the electrical grid.

The example systems and methods described herein can store profile data associated with each residential energy storage device. The profile data can include user setting data, such as a user's preferred discharge time, as well as historical usage data. In certain example embodiments, the historical usage data can be used to build models for use with machine learning to optimize charging and discharging times. The models can incorporate factors such weather, the user's presence at home in the residence, and geography to optimize charging and discharging times. The models also can incorporate data concerning past power outages so that machine learning can be used to predict future power outages and enable availability of energy storage devices to assist with the predicted future power outages. In certain embodiments, the systems and methods described herein can be used with alerts about possible power outages, such as the Flex Alert in California, wherein alerts can trigger the opportunity to use energy storage devices for demand shifting to avert or minimize a predicted power outage.

The example systems and methods described herein can be used to provide information to customers about cost savings realized through the use of an energy storage device. In certain embodiments, information about cost savings, such as average cost savings or typical cost savings in a geographic area, can be shared with customers or potential customers to incentivize use of the energy storage devices described herein.

While the example embodiments disclosed herein are described as charging the energy storage devices with electricity from the electric grid, it should be understood that the systems and methods disclosed herein can be implemented with other energy sources, such as solar and wind power sources.

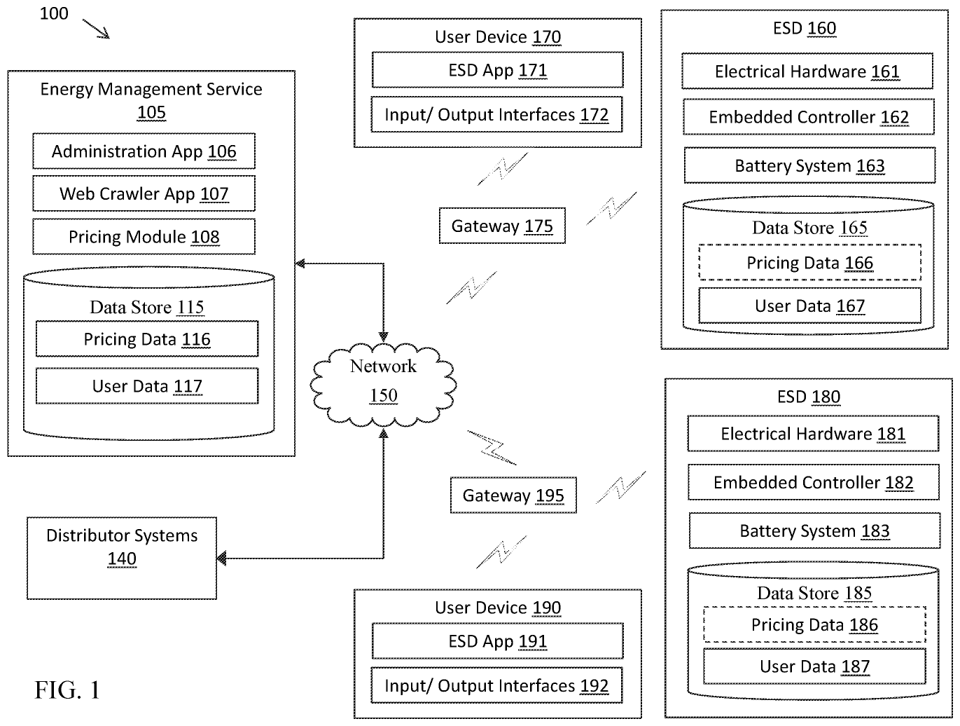

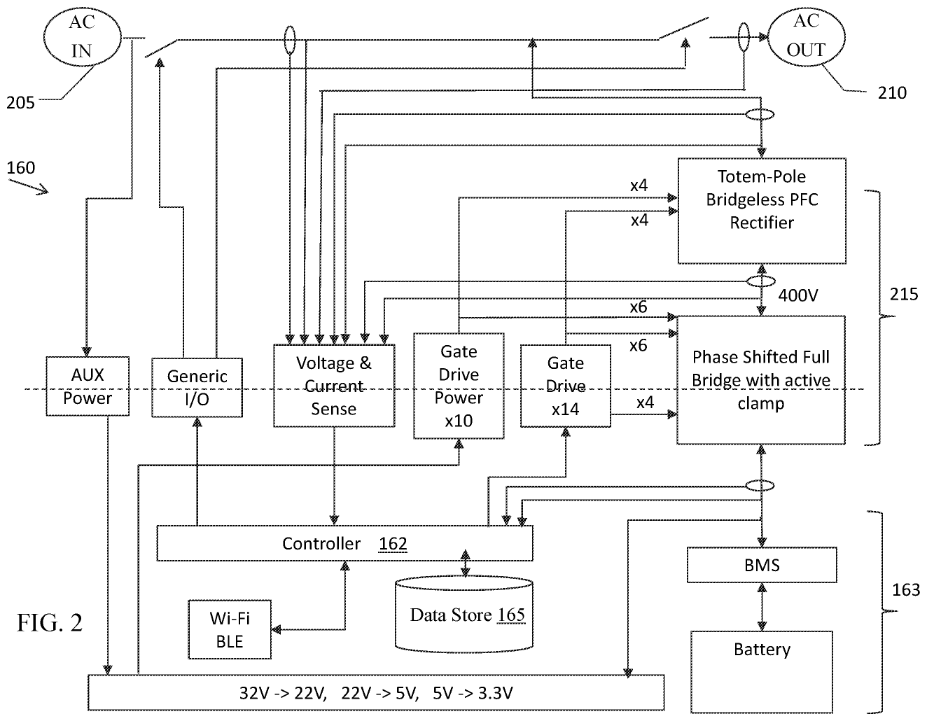

Referring now to FIGS. 1 and 2, block diagrams are provided of example systems in accordance with the disclosed embodiments. FIG. 1 illustrates a system of energy storage devices that can be used to shift energy demand. The example system 100 comprises a first ESD 160 and a second ESD 180. The first and second ESDs can be located within the same residence or business for supplying power to one or more appliances coupled to the ESDs. Alternatively, the ESDs can be located in different residences or businesses. Additionally, only two ESDs are illustrated in system 100 for the sake of simplicity. It should be appreciated that system 100 can support hundreds, thousands, or millions of ESDs located in residences and/or businesses distributed over a wide geographical area.

ESD 160 comprises a battery system 163, an embedded controller 162, electrical hardware 161, and data store 165. The battery system 163 can comprise one or more batteries and a battery managements system. The battery system 163 can comprise new or repurposed battery components. In certain example embodiments, repurposed battery components from other electrical devices including electric vehicles, such as lithium ion batteries, can be used in the battery system 163. Repurposed battery components from electric vehicles present a unique opportunity because when electric vehicle batteries reach the end of their lifecycle, typically 8-10 years during which they can provide sufficient power for a vehicle, they often have 70% to 80% of their useful capacity remaining. Therefore, the battery components for electric vehicles can be repurposed for several more years in the ESDs described herein.

The embedded controller 162 can comprise one or more controllers that manage communications with and the operations of the ESD 160. As one example, the embedded controller 162 can comprise a wireless controller that can communicate via a wireless protocol, such as Wifi and/or Bluetooth, with nearby devices such as Wifi gateway 175 and user device 170. The wireless controller also can manage communications, via the Wifi gateway 175, with remote computing systems such as an energy management service 105 and an energy distributor system 140. In addition to the wireless controller, the embedded controller can comprise a power controller that manages the charging and discharging of the battery system 163. In other embodiments, a user can interact with and operate the controller via a user interface, such as touch screen or key pad, located on an exterior of the ESD 160.

The electrical hardware 161 can comprise connections to the electrical grid and to appliances that receive power from the battery system 163. The electrical hardware 161 can also comprise power converters and electrical connections as will be described further in connection with FIG. 2 below.

The data store 165 can be a persistent computer-readable storage device that can store user data, settings, algorithms, and optionally pricing data used in the operations of the ESD 160. In some embodiments, the data store 165 can be implemented as a component of the embedded controller 162.

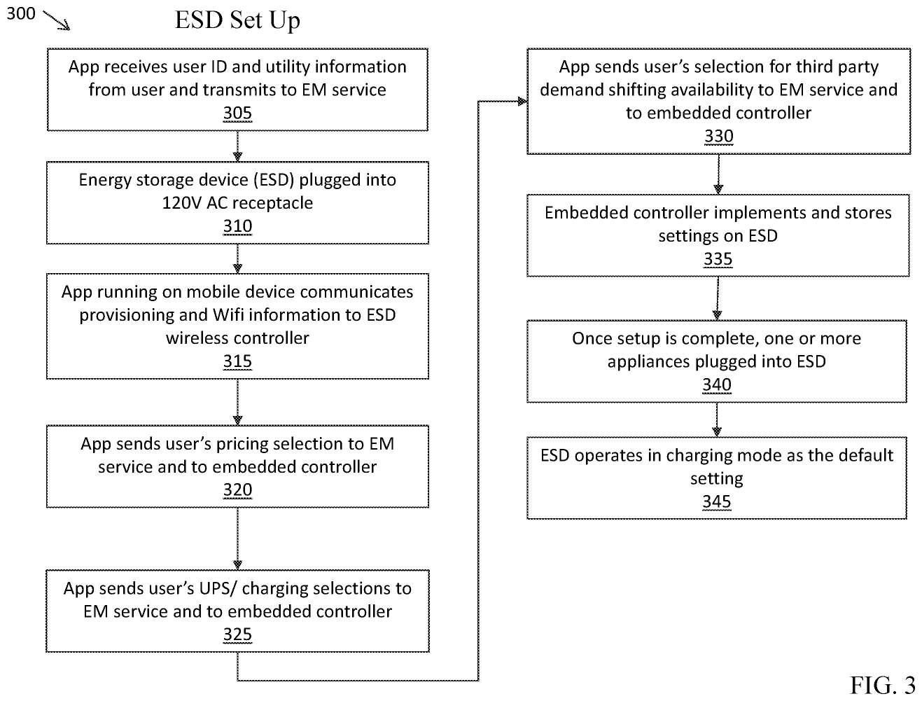

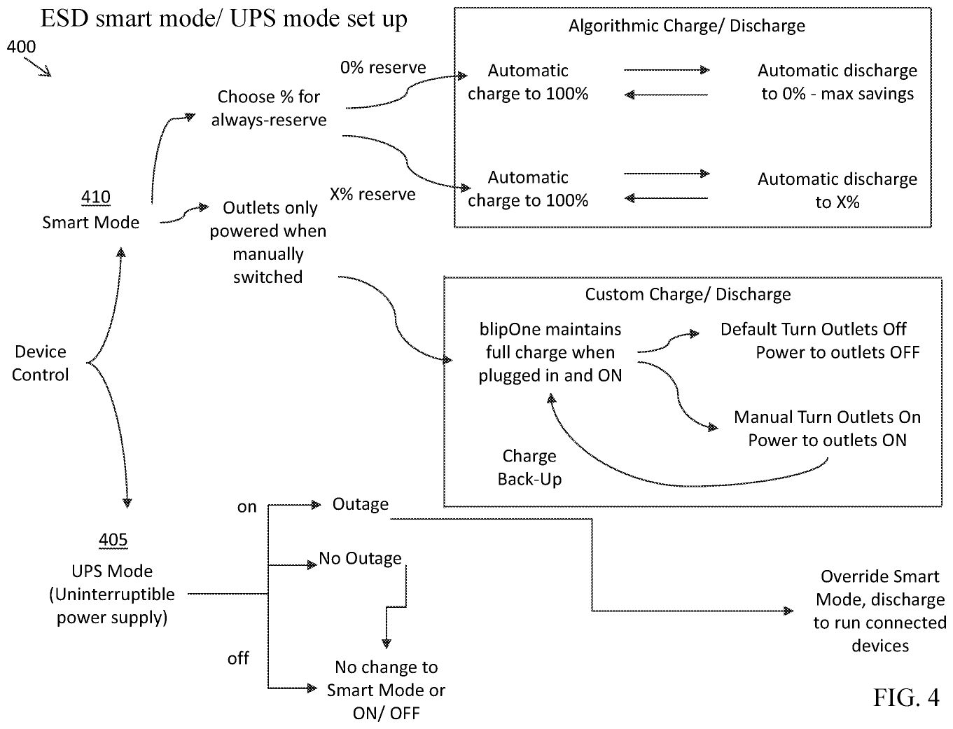

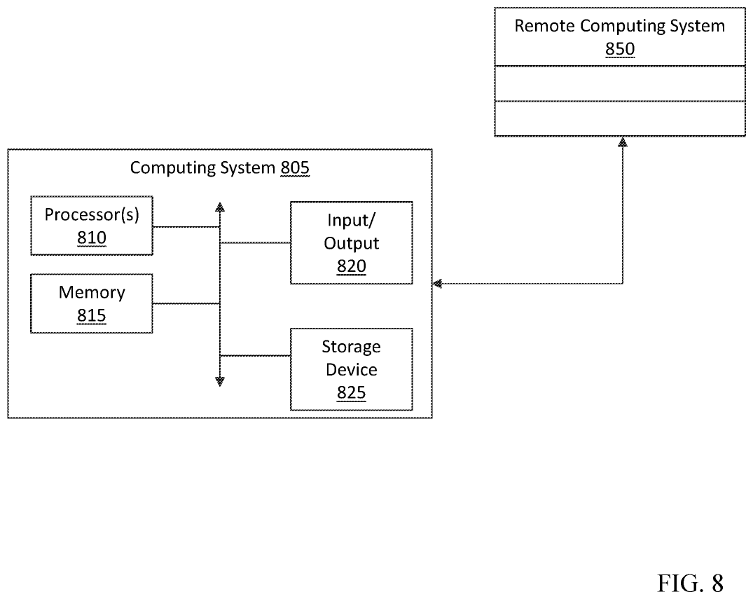

The user device 170 can be a computing device such as a smartphone, a smart tablet computer, a laptop computer, or a desktop computer. The user device 170 can comprise components, such as an input/output interface 192, typically found in a computing device as described further in connection with FIG. 8 below. The user device 170 can include an ESD application 171 that allows a user to communicate with, setup, and control the ESD 160. The setup and control of the ESD 160 will be described further in connection with FIGS. 3 and 4 below.

ESD 180 is another energy storage device similar to ESD 160. ESD 180 comprises a battery system 183, an embedded controller 182, electrical hardware 181, and data store 185, which can include user data 187 and, optionally, pricing data 186. ESD 180 can communicate with user computing device 190, which can comprise input/output interfaces 192 and an ESD application 191. It should be understood that the components and operation of ESD 180, gateway 195, and user device 190 are similar to ESD 160, gateway 195, and user device 190. Accordingly, a detailed description of these components will not be repeated.

ESD 160 and ESD 180 can communicate via network 150, such as the Internet, with an energy management service 105 (also referred to as the EM service). The energy management service 105 can be hosted by one or more remote or cloud computing systems. The energy management service 105 can also be referred to as an energy management computing system. The energy management service 105 can comprise software applications or modules that are used to coordinate the operation of one or more ESDs. Energy management service 105 can comprise an administration application 106, a web crawler application 107, and a pricing module 108. It should be understood that these software applications and modules are merely illustrative and that in alternate embodiments they can be organized in other ways including combining the software applications or incorporating them with other software applications. Energy management service 105 also can comprise data store 115 that can store pricing data 116 and user data 117.

The administration application 106 can interact with the user devices 170, 190 and with the ESDs 160, 180 in connection with the setup and management of the ESDs, including receiving the user settings selections and the status of the ESDs, which data can be stored in the user data 117. The web crawler application 107 can gather pricing data available on the Web from various utilities and such data can be stored as pricing data 116 in data store 115. In addition to the web crawler application 107, or as an alternative thereto, the EM service 105 can integrate with energy providers or other third parties to obtain pricing information. The pricing module 108 can use pricing data 116 to determine when ESDs should switch between charge and discharge modes and to offer suggested pricing plans and discharge strategies to assist consumers and utilities. The operation of the components of the energy management service 105 will be described in further detail in connection with the algorithms illustrated in FIGS. 3-7.

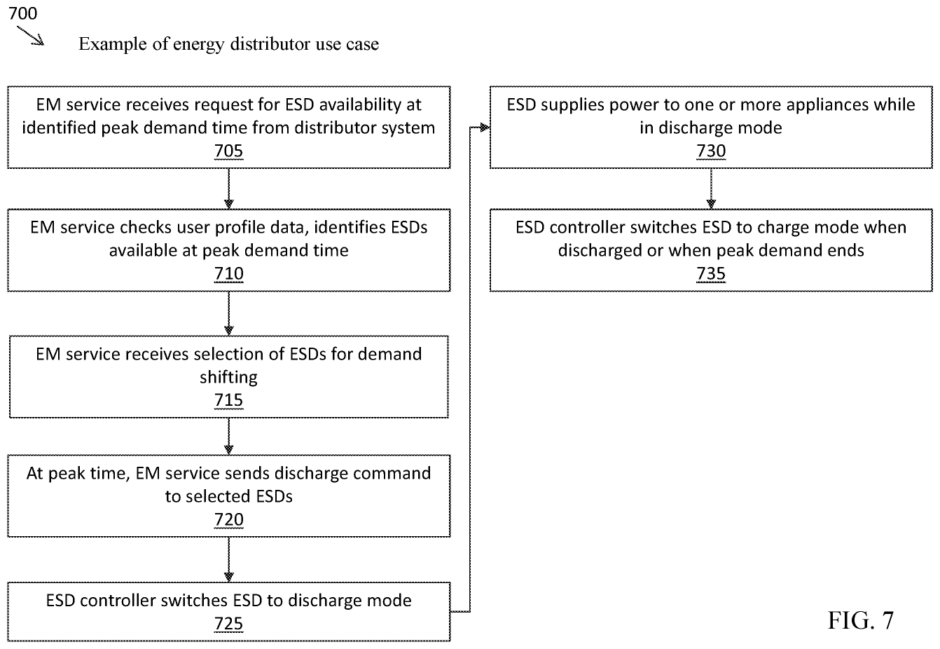

Lastly, FIG. 1 illustrates energy distributor computing systems 140. As will be described further in connection with FIG. 7, the example systems described herein can permit energy distributors, with the permission of the consumers, to use ESDs for reducing energy demand during peak times and during actual or anticipated power outages.

Referring now to FIG. 2, a more detailed block diagram of ESD 160 is illustrated. The components of ESD 160 illustrated in FIG. 2 are merely illustrative examples and in other embodiments the ESD can include alternate components. Beginning with the AC in connection 205, it represents a plug that connects the ESD 160 to a typical electrical receptacle found in a residence or business. The AC in connection 205 allows for charging of the ESD 160 during off-peak times when electricity is relatively less expensive. The AC out connection 210 represents one or more receptacles in the ESD 160 to which one or more electrical appliances can be connected. The AC out connection 210 can include different types of receptacles such as a USB port and a 120 V Hz AC receptacle. When the ESD 160 is in the discharge mode, the AC out connection 210 supplies power to the one or more electrical appliances connected to the AC out connection 210. The relays of the ESD 160 can be arranged so that when in the charging mode, 120V 60 Hz AC power received at the AC in connection 205 from a typical electrical receptacle can be used both i) to charge the battery system 163, and ii) in a flow through capacity whereby the power passes directly to the AC out connection 210 for providing power to an attached electrical appliance.

In general, the power converters 215 can comprise a rectifier for converting an incoming AC signal to a DC signal. The power converters 215 also can comprise an inverter for converting an outgoing DC signal to an AC signal. The power converters also can step up or step down the voltage as appropriate. In the example illustrated in FIG. 2, a totem-pole bridgeless PFC rectifier/inverter is illustrated. The example of FIG. 2 also includes a phase-shifted full-bridge circuit acts as a buck converter in the forward direction and a boost converter in the reverse direction. In other embodiments other types of power conversion components can be implemented.

The battery system 163 comprises a battery management component and one or more batteries. As one example, the battery management component can use passive cell balancing with overcharge and discharge protection, a state of charge meter, backup thermal protection, short circuit protection, and data reporting to the embedded controller 162. As one non-limiting example, it is expected the one or more batteries will have a capacity of 2.2 kWh and a voltage of 48V. The ESD 160 is particularly well-suited for providing power to electrical appliances that require substantial electricity during peak demand times, such as a window air conditioner that typically consumes between 500 W and 1.5 kW. However, other appliances such as a refrigerator or clothes dryer can also be connected to the ESD 160.

The ESD 160 can include voltage and current sensors for measuring the input voltage and current at AC in connection 205, the output voltage and current at AC out connection 210, and the battery voltage and current. The measurements from the voltage and current sensors can be stored in a data store with the ESD 160 and can be transmitted via a wireless controller to the energy management service 105. The voltage and current measurements can be transmitted to the energy management service 105 periodically to indicate the status of the ESD 160. Additionally, the voltage and current measurements can be stored as historical data for the ESD 160 for predicting future use and availability of the ESD 160.

Referring now to FIGS. 3-7, example methods will be described for the operation of an energy storage device such as ESDs 160 and 180. The example methods of FIGS. 3-7 can be implemented as one or more algorithms using software applications or modules executing on one or more processors. It should be understood that the methods illustrated in FIGS. 3-7 are merely illustrative examples and in other embodiments the methods can be modified by combining operations, adding or removing operations, or performing operations in parallel or in a different order.

Referring to FIG. 3, an example method 300 is illustrated for setting up an energy storage device such as ESDs 160 and 180. Example method 300 can be performed with the assistance of the previously-described ESD application executing on a consumer's computing device. In step 305, the ESD application can receive a user identifier and the user's utility information and can transmit the information to the energy management service 105. As described previously, the energy management service can comprise one or more software applications and modules executing on an energy management computing system. In operation 310, the user connects the ESD to an AC power receptacle, such as a typical 120V 60 Hz AC power receptacle typically found in a residence or business. In operation 315, the ESD application can communicate provisioning and Wifi network information to the embedded wireless controller in the ESD so that the ESD can communicate via a wireless gateway.

In operation 320, the user can make a pricing selection using the ESD application and the ESD application can send the pricing selection to the energy management service 105 and to the ESD's embedded controller 162. As one example, the pricing selection can indicate an energy pricing differential that triggers the ESD to switch from a charging mode to a discharging mode. The consumer can select that any time the price of energy rises above a certain differential, the ESD will switch from charging mode to discharging mode to mitigate the impact of the higher price. As another example, the pricing selection could be based on a time of use and indicate that the ESD will switch from charging mode to discharging mode during a particular time of the day when energy prices are typically higher. In an alternate embodiment, the energy management service can make a recommendation to the consumer of a particular price plan or time-of-use plan to optimize cost savings. Thus, the user can implement one or more ESD's at a residence or business that can be charged at times of the day when electricity demand is off-peak and therefore less expensive. Subsequently, the charged ESDs can provide stored power to one or more electrical appliances during peak demand times thereby reducing demand for the utility and saving the customer on energy costs.

Referring to operation 325, the ESD application can receive the user's selections with respect to charging percentages for the batteries and an uninterruptible power supply mode and can send the user's selections to the embedded controller 162 and EM service 105. In operation 330, the ESD application can receive the user's selections with respect making the ESD available for energy distributor demand shifting and can send the user's selections to the embedded controller 162 and the EM service 105. In operation 335, the embedded controller 162 stores the user's selections for use during the operation of the ESD 160. In operation 340, one or more electrical appliances can be plugged into the AC out connection 210. Lastly, in operation 345, the ESD begins operating in charge mode as the default setting.

Referring to FIG. 4, an example method 400 is illustrated. Example method 400 can be used to make the charging settings referenced in operation 325 of FIG. 3. The system 100 and the ESD application 171 can provide the user with a variety of options with respect to setting parameters relating to charging and discharging of the ESD 160. As referenced at operation 405, the ESD application 171 can provide the user with the option to select an uninterruptible power supply (“UPS”) mode. When activated, the UPS mode can override other discharge settings so that the ESD 160 preserves the charged battery system for a power outage. When there is no power outage and the ESD 160 is in UPS mode, electrical appliances plugged into the ESD 160 will receive power from the grid that passes through the ESD 160 in a flow through capacity. When in UPS mode and a power outage occurs, the ESD 160 will discharge the power stored in the battery system to supply power to the one or more electrical appliances connected to the ESD 160.

Another option illustrated in FIG. 4 that the system 100 and the ESD application 171 provide to the user is to select a smart mode as referenced at operation 410. The smart mode permits a user to select charging parameters including a charge reserve percentage. As one example, the user can choose to require that the ESD 160 charge to 100% of capacity or another lesser capacity before discharging to power a connected electronic appliance. As another example, the user can set the ESD 160 so that it will always maintain a minimum charge threshold (e.g., 40% of capacity) and will not discharge below that minimum charge threshold unless there is a power outage. The minimum charge threshold can be a useful reserve of power in the event a power outage occurs. It should be understood that alternate embodiments can employ other charge settings and UPS mode settings that are variations of operations 405 and 410 illustrated in FIG. 4.

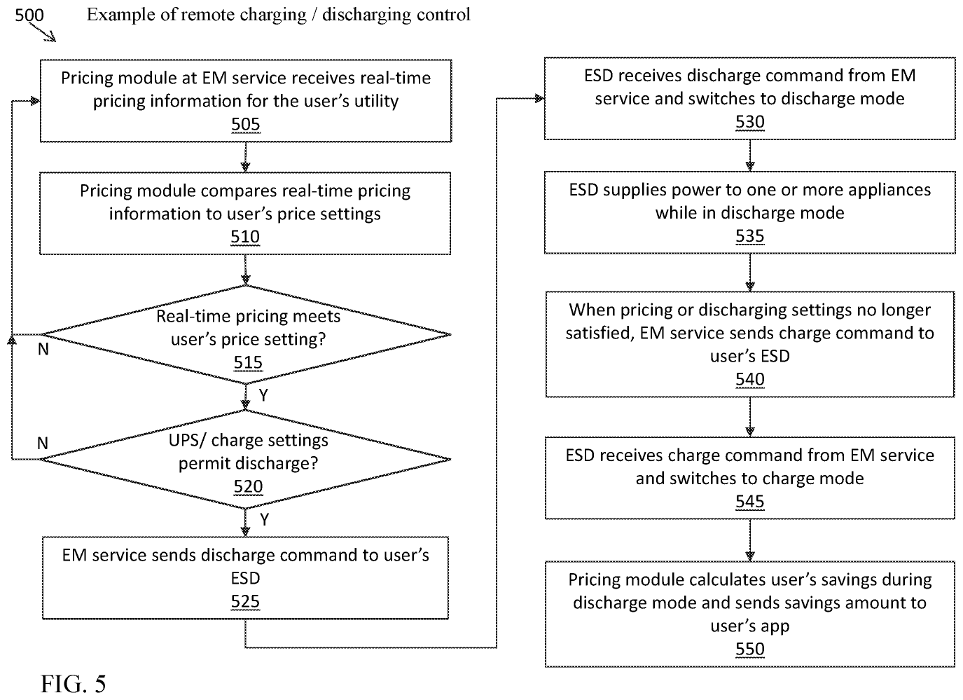

Referring now to FIG. 5, example method 500 is illustrated for controlling the charging and discharging of an ESD, such as ESDs 160 and 180. The example of method 500 involves control decisions at the energy management service 105 which is implemented in a computing system that is remote from one or more ESDs. Beginning with operation 505, the pricing module 108 of the EM service 105 receives real-time pricing information for a user's utility. “Real-time” typically refers to pricing information that is current within 30 minutes, or preferably current within 15 minutes, because energy pricing can change frequently throughout the day based on demand, weather conditions, and other factors. The web crawler application 107 can gather utility pricing information from the Web and regularly update the pricing information stored as pricing data 116. In operation 510, the pricing module 108 compares the current pricing information to the user's price setting to determine whether the user's ESD should be switched to a discharge mode to achieve energy savings. It can be assumed that at this point the ESD is in a charging mode as the default mode of operation. In operation 515, the pricing module 108 determines whether the current pricing information meets the user's price setting. The comparison the pricing module performs can take a variety of forms. For example, the user's price setting could be a threshold amount above the average off-peak price for power. Alternatively, the user's price setting could vary depending on the time of day or the time of year.

As another alternative, the pricing module 108 can regularly review available energy prices and provide a recommendation to the user of optimal times for switching the ESD to discharge mode. In certain instances, recommendations can be based on historical energy price data and a prediction of the optimal times for switching the ESD between charge mode and discharge mode. In other instances, recommendations can be based on information that includes historical information associated with user's use of the ESD. Historical information associated with the user's ESD can be used to identify opportunities when the ESD is charged and can be used to achieve energy cost savings. In yet other instances, recommendations can be based on forecasted weather or other environmental conditions such as wildfires that can impact the availability and price of energy from the electrical grid. If adverse weather or environmental conditions are predicted, the EM service 105 can provide an alert to the user via the ESD application 171 that the ESD may be needed to provide stored power. In certain instances, recommendations for switching to the discharge mode can be based on one or more of historical energy prices, historical data associated with the user's use of the ESD, and forecasted weather or environmental conditions.

If the price setting is satisfied, the method proceeds to operation 520 wherein the EM service can confirm whether the user's UPS and charge settings permit a discharge operation. For example, if the user has activated the UPS mode and there is no power outage at the present time, the user's settings will prevent a discharge of the ESD. As another example, if the data gathered from the current and voltage sensors of the ESD indicates the ESD is only 25% charged and the user has set a 45% minimum charge threshold, the ESD cannot be switched to a discharge mode until the ESD is charged to more than 45% of its capacity. If the UPS and charge settings are satisfied in operation 520, the EM service 105 transmits a discharge command via network 150 to the embedded controller of the user's ESD in operation 525. Alternatively, if either the price setting or the UPS/charging setting are not satisfied, the method 500 can return to operation 505.

In operation 530, the ESD's embedded controller receives the discharge command and switches the ESD to discharge mode. Once in discharge mode, the ESD's battery system can supply power to one or more electrical appliances connected to the ESD in operation 535. In operation 540, when pricing or charging settings are no longer satisfied, the EM service 105 sends a charge command via network 150 to the user's ESD. In one example, the EM service 105 can regularly monitor changes in energy pricing and/or the charge status of the ESD to determine when the settings are no longer satisfied. In alternative embodiments, the discharge command from the EM service 105 can have an associated time duration after which pricing and charging settings can be checked or after which the ESD can automatically switch to charging mode. When the ESD receives a charge command from the EM service 105 in operation 545, the embedded controller will switch the ESD from discharge mode to charge mode and the battery system will resume charging with power from the electrical grid.

Operation 550 provides energy cost savings to the user. Specifically, the pricing module 108 calculates energy savings the user accrued by using stored energy from the ESD during the discharge mode instead of more expensive energy from the electrical grid during a period of peak demand. The calculated energy cost savings can be transmitted to the ESD application 171 and displayed on the user's computing device 170. In certain embodiments, energy cost savings can be calculated for a group of users or a geographic area and the energy cost savings can be shared with existing or prospective users to encourage use of the ESDs to optimize energy savings. Energy cost savings data can also be accumulated by the EM service 105 for making future recommendations to users. For instance, historical energy cost savings data can be combined with historical charge and discharge data associated with one or more users to develop a model for predicting optimal operation of the ESDs to improve energy cost savings.

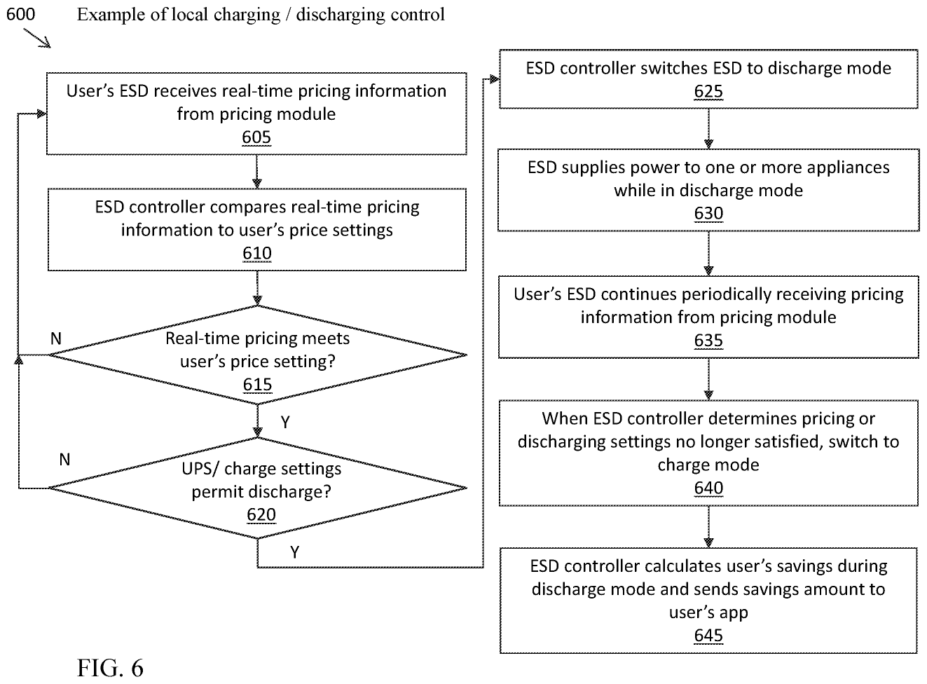

Referring now to FIG. 6, example method 600 is illustrated for controlling the charging and discharging of an ESD, such as ESDs 160 and 180. In contrast to example method 500, example of method 600 involves local control decisions at the ESD. Beginning with operation 605, the pricing module 108 of the EM service 105 receives real-time pricing information for a user's utility and supplies the pricing information to the user's ESD via network 150 and the wireless controller embedded in the ESD. Previously, during the setup of the ESD, the user can have stored the user's price settings as pricing data in the data store 165. In operation 610, the embedded controller 162 can compare the pricing information to the user's price settings. As described previously in connection with method 500, the user's price settings can take a variety of forms, such as a differential from the average off-peak energy price or a price at a particular time of day or time of the year.

As an alternative to the user's price settings, similar to the description of recommended discharge periods provided in connection with method 500 of FIG. 5, the embedded controller 162 of the ESD can provide a recommendation via the ESD application 171 as to when the ESD should be switched to discharge mode. Such recommendations can be based on one or more of historical energy prices, historical data associated with the user's use of the ESD, and forecasted weather or environmental conditions.

In operations 615 and 620, the embedded controller can determine whether the criteria set by the user's price setting, UPS setting, and charge setting are satisfied. The UPS setting and charge setting referenced in operation 620 can be similar to the settings described previously in connection with operation 520 of FIG. 5. If the criteria in operations 615 and 620 are not satisfied, the method 600 returns to operation 605. Alternatively, if the criteria in operations 615 and 620 are satisfied, the embedded controller 162 can switch the ESD from the charge mode to the discharge mode in operation 625.

Once in discharge mode, the ESD's battery system can supply power to one or more electrical appliances connected to the ESD in operation 630. In operation 635, the ESD can receive regular updates of real-time pricing information from the pricing module of the EM service 105. In operation 640, when the embedded controller 162 determines pricing or charging settings are no longer satisfied, the embedded controller 162 switches the ESD from discharge mode to charge mode. In one example, the embedded controller 162 can regularly monitor changes in energy pricing and/or the charge status of the ESD to determine when the settings are no longer satisfied. In alternative embodiments, the discharge mode can have an associated time duration after which pricing and charging settings can be checked or after which the embedded controller can automatically switch to charging mode.

Operation 645 provides energy cost savings to the user. For example, the embedded controller 162 can calculate the savings accrued during the discharge mode by comparing the energy price used to charge the battery system during an off-peak demand time period against the energy price during the peak demand time that was avoided by discharging the ESD. The calculated energy cost savings can be transmitted in a message to the ESD application 171 for display on the user's computing device 170.

Referring now to FIG. 7, example method 700 is illustrated for enabling an energy distributor to use one or more ESDs for shifting electricity demand during a peak demand time. Being able to shift demand during a peak demand time so that a portion of the energy demand is satisfied by energy storage devices can assist in avoiding the need to activate peaker power plants and/or avoid the occurrence of power outages. The method 700 of FIG. 7 can be initiated by an energy distributor computing system 140 communicating with the EM service 105. Alternatively, in another embodiment, the energy distributor can operate the EM service 105. In operation 705, the EM service 105 receives a request from the energy distributor computing system 140 for ESD availability at an identified peak energy demand time. In operation 710, the EM service 105 can check user data stored in data store 115 to identify ESDs that can be available at the peak demand time. When ESDs are setup and registered with the EM service 105, the EM service 105 stores user data in the form a user profile that can include UPS settings, charge/discharge settings, and whether the user decides to make the ESD available to energy distributors for demand shifting. Once the available ESDs are identified for the energy distributor computing system 140, the EM service receives a selection of ESDs to be used for energy demand shifting in operation 715. Depending on need or projected demand, the energy distributor can select all or a subset of the ESDs available for demand shifting. As one example, the energy distributor may select ESDs located in a particular geographic area.

When the peak energy demand period occurs, in operation 720 the EM service 105 can send discharge commands to the ESDs selected in operation 715. In operation 725, each ESD that receives a discharge command switches from a charge mode to a discharge mode. In operation 730, the ESDs that switched to discharge mode supply stored power to one or more electrical appliances coupled to the selected ESDs. Switching numerous ESDs distributed over customers in a particular area can alleviate demand on the electrical grid during a peak demand time. In operation 735, the embedded controllers in the respective ESDs switch from discharge mode to charge mode when the ESDs have reached their respective minimum charge thresholds or when the peak energy demand period has ended.

In alternate embodiments, example method 700 can be modified to rely on historical data to predict when ESDs are available for demand shifting. For example, the EM service 105 can use historical ESD use data to predict when ESDs will be available for demand shifting. The EM service 105 can provide the predicted availability of ESDs to energy distributors for purposes of planning to address peak demand times or times of weather or environmental conditions when the ESDs may be needed to supply stored power.

### Computing Systems

In certain embodiments, some or all of the processing operations described in connection with the foregoing methods can be performed by computing systems such as a personal computer, a desktop computer, a centralized computer, or cloud computing systems. As explained previously, certain operations of the foregoing methods can be performed by a combination of computing systems.

Referring to FIG. 8, an example of a computing system is illustrated. The computing system 805 can represent a component of or one of the computing systems previously described herein, including the computing systems from which the ESD management service is provided, the computing components of the residential energy storage devices, and the user computing devices. Computing system 805 includes a processor 810, a memory 815, an input/output device 820, and a storage device 825. Each of the components of the computing system 805 can be interconnected, for example, by a system bus. The components of computing system 805 shown in FIG. 8 are not exhaustive, and in some embodiments, one or more of the components shown in FIG. 8 may not be included in an example system. Further, one or more components shown in FIG. 8 can be rearranged.

The processor 810 can be one or more hardware processors and can execute computer-readable instructions, such as instructions stored in memory 815. The processor 810 can be an integrated circuit, a central processing unit, a multi-core processing chip, an SoC, a multi-chip module including multiple multi-core processing chips, or other hardware processor in one or more example embodiments. The hardware processor is known by other names, including but not limited to a computer processor, a microprocessor, and a multi-core processor.

The memory 815 can store information including computer-readable instructions and data associated with the fulfillment center. The memory 815 can be cache memory, a main memory, and/or any other suitable type of memory. The memory 815 is a non-transitory computer-readable medium. In some cases, the memory 815 can be a volatile memory device, while in other cases the memory can be a non-volatile memory device.

The storage device 825 can be a non-transitory computer-readable medium that provides large capacity storage for the computing system 805. The storage device 825 can be a disk drive, a flash drive, a solid state device, or some other type of storage device. In some cases, the storage device 825 can be a database that is remote from the computing system 805. The storage device can store operating system data, file data, database data, algorithms, and software modules, as examples. The algorithms stored in the storage device can embody the operations of the methods described herein. The storage device can also store user data and pricing data in association with the operation of the systems and methods described herein.

Lastly, the input/output device 820 provides an interface to other devices, such as a touch screen interface, and other computing systems such as remote computing system 850. The input/output device 820 can provide signal transfer links for communications with other devices and computing systems. The signal transfer links can include wired and/or wireless signal transfer links that transmit and receive communications via known communication protocols. In some instances, the input/output device 820 can include a wired or wireless network interface device.

### Assumptions and Defined Terms

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain operations of the methods may be performed in a different order, may be performed in parallel, or may be omitted. Moreover, in alternate embodiments additional operations may be added to the example methods described herein. Accordingly, the example methods provided herein should be viewed as illustrative and not limiting of the disclosure.

Unless otherwise noted herein, the terms “user” and “consumer” are used interchangeably herein and have the same meaning.

As used herein, the term “utility” refers to any entity that provides energy including traditional electrical utilities as well as other public and private energy providers. Additionally, it should be understood that the systems and embodiments described herein can be integrated with wholesale power markets, either directly or through third parties.

As used herein, “peak” demand refers to one or both of times when energy is in higher demand than average and times when energy is in lower supply than average.

Terms such as “first” and “second” are used merely to distinguish one element or operation from another. Such terms are not meant to denote a preference or a particular order, and are not meant to limit the embodiments described herein. In the example embodiments described herein, numerous specific details are set forth in order to provide a more thorough understanding of the disclosure. However, it will be apparent to one of ordinary skill in the art having regard to the present application that the embodiments may be practiced without these specific details. In other instances, well-known features have not been described in detail to avoid unnecessarily complicating the description.

As used herein, the terms “a,” “an,” and “the” are intended to include plural alternatives, e.g., at least one. The phrase “and/or” means either or both. Similarly, when used in a list of items, the word “or” means either or both. However, when “or” is preceded by “either” or similar terms, it shall be interpreted as meaning exclusive alternatives. The terms “including”, “with”, and “having”, as used herein, are defined as comprising (i.e., open language), unless specified otherwise.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In addition to the forgoing, the various embodiments of the present disclosure include, but are not limited to, the embodiments set forth in the following clauses.
Clause 1. A computer-implemented method comprising: obtaining, at an energy management computing system, an energy price for energy supplied by a utility associated with a user; comparing the energy price with a price setting determined by the user; and responsive to the energy price satisfying the price setting, transmitting, from the energy management computing system to a controller of an energy storage device associated with the user, a discharge command, wherein the discharge command causes the energy storage device to complete a discharge cycle during which the energy storage device delivers power from a battery system to an electrical appliance coupled to the energy storage device.
Clause 2. The computer-implemented method of clause 1, wherein the energy storage device is located remotely from the energy management computing system; and wherein the discharge command is transmitted from the energy management computing system to the controller of the energy storage device via the Internet.
Clause 3. The computer-implemented method of any of clauses 1 or 2, further comprising: prior to transmitting the discharge command, confirming that an uninterruptible power supply mode is deactivated.
Clause 4. The computer-implemented method of any of clauses 1-3, further comprising: prior to transmitting the discharge command, comparing a charge status for the energy storage device to a charge threshold setting for the energy storage device; and confirming that the charge status satisfies the charge threshold setting.
Clause 5. The computer-implemented method of any of clauses 1-4, wherein the discharge command comprises a discharge percentage that determines a percentage to which the battery system will be discharged.
Clause 6. The computer-implemented method of any of clauses 1-5, further comprising: responsive to determining, by the energy management computing system, that the energy price no longer satisfies the price setting, transmitting, from the energy management computing system to the controller of the energy storage device, a charge command, wherein the charge command causes the energy storage device to end the discharge cycle and begin charging the battery system; calculating a cost savings accrued during the discharge cycle, the cost savings based on the energy price; and transmitting, from the energy management computing system to a user device associated with the energy storage device, a message comprising the cost savings.
Clause 7. The computer-implemented method of any of clauses 1-6, further comprising: responsive to determining, by the energy management computing system, that a charge status for the energy storage device no longer satisfies a charge threshold setting, transmitting, from the energy management computing system to the controller of the energy storage device, a charge command, wherein the charge command causes the energy storage device to end the discharge cycle and begin charging the battery system; calculating a cost savings accrued during the discharge cycle, the cost savings based on the energy price; and transmitting, from the energy management computing system to a user device associated with the energy storage device, a message comprising the cost savings.
Clause 8. The computer-implemented method of any of clauses 1-7, wherein the battery system comprises recycled battery components.
Clause 9. A computer-implemented method comprising: receiving, at a controller of an energy storage device from an energy management computing system, an energy price for energy supplied by a utility associated with a user; comparing the energy price with a price setting determined by the user; and responsive to the energy price satisfying the price setting, switching, by the controller, the energy storage device from a charge mode to a discharge mode, wherein the discharge mode causes the energy storage device to complete a discharge cycle during which the energy storage device delivers power from a battery system to an electrical appliance coupled to the energy storage device.
Clause 10. The computer-implemented method of clause 9, wherein the energy storage device is located remotely from the energy management computing system; and wherein the energy price is transmitted from the energy management computing system to the controller of the energy storage device via the Internet.
Clause 11. The computer-implemented method of any of clauses 9-10, further comprising: prior to switching to the discharge mode, confirming that an uninterruptible power supply mode is deactivated.
Clause 12. The computer-implemented method of any of clauses 9-11, further comprising: prior to switching to the discharge mode, comparing a charge status for the energy storage device to a charge threshold setting for the energy storage device; and confirming that the charge status satisfies the charge threshold setting.
Clause 13. The computer-implemented method of any of clauses 9-12, wherein the charge threshold setting is a minimum percentage charge that is maintained by the battery system.
Clause 14. The computer-implemented method of any of clauses 9-13, further comprising: responsive to determining, by the controller, that the energy price no longer satisfies the price setting, switching, by the controller, the energy storage device from the discharge mode to the charge mode to end the discharge cycle and begin charging the battery system; calculating a cost savings accrued during the discharge cycle, the cost saving based on the energy price; and transmitting, from the controller to a user device associated with the energy storage device, a message comprising the cost savings.
Clause 15. The computer-implemented method of any of clauses 9-14, further comprising: responsive to determining, by the controller, that a charge status for the energy storage device no longer satisfies a charge threshold setting, switching, by the controller, the energy storage device from the discharge mode to the charge mode to end the discharge cycle and begin charging the battery system; calculating a cost savings accrued during the discharge cycle, the cost savings based on the energy price; and transmitting, from the controller to a user device associated with the energy storage device, a message comprising the cost savings.
Clause 16. The computer-implemented method of any of clauses 9-15, wherein the battery system comprises recycled battery components.
Clause 17. A computer-implemented method comprising: receiving, at an energy management computing system from an energy distributor computing system, a request for energy storage device availability at an identified peak demand time; identifying, by the energy management computing system for the energy distributor computing system, a plurality of energy storage devices available at the identified peak demand time by comparing the identified peak time to profile data associated with the plurality of energy storage devices; receiving, at the energy management computing system from the energy distributor computing system, selected energy storage devices of the plurality of energy storage devices for demand shifting; transmitting, by the energy management computing system to the selected energy storage devices, a discharge command, wherein the discharge command causes the selected energy storage devices to complete a discharge cycle during which the selected energy storage devices deliver power from a respective battery system to a respective electrical appliance.
Clause 18. The computer-implemented method of clause 17, wherein the profile data comprises a demand shifting selection and historical usage data associated with the plurality of energy storage devices.
Clause 19. The computer-implemented method of any of clauses 17-18, further comprising: responsive to determining, by the energy management computing system, that an identified peak demand time has ended, transmitting, from the energy management computing system to the selected energy storage devices, a charge command, wherein the charge command causes the selected energy storage devices to end the discharge cycle and begin charging the respective battery systems.
Clause 20. The computer-implemented method of any of clauses 17-19, further comprising: calculating a cost savings accrued during the discharge cycle for at least one of the selected energy storage devices, the cost savings based on an energy price during the identified peak demand time; and transmitting, from the energy management computing system to a user device associated with the at least one of the selected energy storage devices, a message comprising the cost savings.

Although embodiments described herein are made with reference to example embodiments, it should be appreciated by those skilled in the art having regard to the present application that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A computer-implemented method comprising:
obtaining, at an energy management computing system, an energy price for energy supplied by a utility associated with a user;
comparing the energy price with a price setting determined by the user; and
responsive to the energy price satisfying the price setting, transmitting, from the energy management computing system to a controller of an energy storage device associated with the user, a discharge command,
wherein the discharge command causes the energy storage device to complete a discharge cycle during which the energy storage device delivers power from a battery system to an electrical appliance coupled to the energy storage device.

2. The computer-implemented method of claim 1,
wherein the energy storage device is located remotely from the energy management computing system; and
wherein the discharge command is transmitted from the energy management computing system to the controller of the energy storage device via the Internet.

3. The computer-implemented method of claim 1, further comprising:
prior to transmitting the discharge command, confirming that an uninterruptible power supply mode is deactivated.

4. The computer-implemented method of claim 1, further comprising:
prior to transmitting the discharge command,
comparing a charge status for the energy storage device to a charge threshold setting for the energy storage device; and
confirming that the charge status satisfies the charge threshold setting.

5. The computer-implemented method of claim 1, wherein the discharge command comprises a discharge percentage that determines a percentage to which the battery system will be discharged.

6. The computer-implemented method of claim 1, further comprising:
responsive to determining, by the energy management computing system, that the energy price no longer satisfies the price setting,
transmitting, from the energy management computing system to the controller of the energy storage device, a charge command, wherein the charge command causes the energy storage device to end the discharge cycle and begin charging the battery system;
calculating a cost savings accrued during the discharge cycle, the cost savings based on the energy price; and
transmitting, from the energy management computing system to a user device associated with the energy storage device, a message comprising the cost savings.

7. The computer-implemented method of claim 1, further comprising:
responsive to determining, by the energy management computing system, that a charge status for the energy storage device no longer satisfies a charge threshold setting,
transmitting, from the energy management computing system to the controller of the energy storage device, a charge command, wherein the charge command causes the energy storage device to end the discharge cycle and begin charging the battery system;
calculating a cost savings accrued during the discharge cycle, the cost savings based on the energy price; and
transmitting, from the energy management computing system to a user device associated with the energy storage device, a message comprising the cost savings.

8. The computer-implemented method of claim 1, wherein the battery system comprises recycled battery components.

9. A computer-implemented method comprising:
receiving, at a controller of an energy storage device from an energy management computing system, an energy price for energy supplied by a utility associated with a user;
comparing the energy price with a price setting determined by the user; and
responsive to the energy price satisfying the price setting, switching, by the controller, the energy storage device from a charge mode to a discharge mode,
wherein the discharge mode causes the energy storage device to complete a discharge cycle during which the energy storage device delivers power from a battery system to an electrical appliance coupled to the energy storage device.

10. The computer-implemented method of claim 9,
wherein the energy storage device is located remotely from the energy management computing system; and
wherein the energy price is transmitted from the energy management computing system to the controller of the energy storage device via the Internet.

11. The computer-implemented method of claim 9, further comprising:
prior to switching to the discharge mode, confirming that an uninterruptible power supply mode is deactivated.

12. The computer-implemented method of claim 9, further comprising:
prior to switching to the discharge mode,
comparing a charge status for the energy storage device to a charge threshold setting for the energy storage device; and
confirming that the charge status satisfies the charge threshold setting.

13. The computer-implemented method of claim 12, wherein the charge threshold setting is a minimum percentage charge that is maintained by the battery system.

14. The computer-implemented method of claim 9, further comprising:
responsive to determining, by the controller, that the energy price no longer satisfies the price setting,
switching, by the controller, the energy storage device from the discharge mode to the charge mode to end the discharge cycle and begin charging the battery system;
calculating a cost savings accrued during the discharge cycle, the cost saving based on the energy price; and
transmitting, from the controller to a user device associated with the energy storage device, a message comprising the cost savings.

15. The computer-implemented method of claim 9, further comprising:
responsive to determining, by the controller, that a charge status for the energy storage device no longer satisfies a charge threshold setting,
switching, by the controller, the energy storage device from the discharge mode to the charge mode to end the discharge cycle and begin charging the battery system;
calculating a cost savings accrued during the discharge cycle, the cost savings based on the energy price; and
transmitting, from the controller to a user device associated with the energy storage device, a message comprising the cost savings.

16. The computer-implemented method of claim 9, wherein the battery system comprises recycled battery components.

17. A computer-implemented method comprising:
receiving, at an energy management computing system from an energy distributor computing system, a request for energy storage device availability at an identified peak demand time;
identifying, by the energy management computing system for the energy distributor computing system, a plurality of energy storage devices available at the identified peak demand time by comparing the identified peak time to profile data associated with the plurality of energy storage devices;
receiving, at the energy management computing system from the energy distributor computing system, selected energy storage devices of the plurality of energy storage devices for demand shifting;
transmitting, by the energy management computing system to the selected energy storage devices, a discharge command,
wherein the discharge command causes the selected energy storage devices to complete a discharge cycle during which the selected energy storage devices deliver power from a respective battery system to a respective electrical appliance.

18. The computer-implemented method of claim 17, wherein the profile data comprises a demand shifting selection and historical usage data associated with the plurality of energy storage devices.

19. The computer-implemented method of claim 17, further comprising:
responsive to determining, by the energy management computing system, that an identified peak demand time has ended,
transmitting, from the energy management computing system to the selected energy storage devices, a charge command, wherein the charge command causes the selected energy storage devices to end the discharge cycle and begin charging the respective battery systems.

20. The computer-implemented method of claim 19, further comprising:
calculating a cost savings accrued during the discharge cycle for at least one of the selected energy storage devices, the cost savings based on an energy price during the identified peak demand time; and
transmitting, from the energy management computing system to a user device associated with the at least one of the selected energy storage devices, a message comprising the cost savings.
